(19) United States
(12) Patent Application Publication
(10) Pub. No.: US 2004/0093916 A1
(43) Pub. Date: May 20, 2004

(54) Securing device adapted to secure equipment having screw holes

(76) Inventor: Renny Tse-Haw Ling, Chung-Ho City (TW)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/328,099

(22) Filed: Dec. 23, 2002

(30) Foreign Application Priority Data
May 31, 2002 (TW) 091208048

(51) Int. Cl. E05B 73/00

(52) U.S. Cl. 70/58

(57) ABSTRACT

A securing device, comprising: at least one fastening device for engaging a screw hole; a lock mechanism to be switched between an unlocked state and a locked state, and for enveloping the at least one fastening device to assume the locked state, such that the at least one fastening device cannot be detached from the screw hole; and a cable, having an end fixed to the lock mechanism and another end to be connected to a fixture. Based on such disclosures, further disclosed is a securing device adapted for securing a connector, where a covering member for covering the connector is provided to the fastening device, such that when the fastening device engages screw holes at an outer periphery of the connector housing, the covering member covers the connector such that the connector cannot be used.

### CROSS-REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention is related to a securing device, in particular, on adapted to secure equipment having screw holes, and to secure the equipment to a fixture.

2. Description of the Related Art

Computer users, particularly the users of the laptop computers, frequently worry about possible theft of their computers. Further, the current computer, either a desktop computer or a laptop computer 1, as shown in FIG. 1, has a plurality of connectors 10 thereon for connecting with various accessories or main server to transmit data files. However, the existence of the connector may also lead to the possible stealing of the data files from the computer by connecting a transmitting cable to the connector. Thus, there is a need to provide a device to prevent unauthorized connection to the computer though the connector.

### BRIEF SUMMARY OF THE INVENTION

A primary objective of this invention is to satisfy the above needs, to provide a securing device to be adapted to equipments such as computers, for preventing theft of the equipments while particular components (such as connectors) provided on the secured equipment can prevent unauthorized connection.

The securing device of this invention may be widely implemented in various equipments (including computers) equipped with screw holes, comprising: at least one fastening device for engaging a screw hole; a lock mechanism to be switched between an unlocked state and a locked state, and for enveloping the at least one fastening device to assume the locked state, such that the at least one fastening device cannot be detached from the screw hole; and a cable, having an end fixed to the lock mechanism and another end to be connected to a fixture.

Based on such disclosures, the equipment secured by the securing device may be further connected to a fixture through the engagement between the securing device and the screw hole, such that the equipment may be secured and prevent theft.

Based on the above disclosures, this invention further discloses a securing device adapted for securing a connector having screw holes at its outer periphery for engaging with a connector of a transmitting cable. The fastening device of this invention may be further provided to a covering member, such that when the fastening device engages the screw holes provided next to the connector, the covering member covers the connector such that the connector cannot be used.

As such, the possibility of stealing of the data files from the computer by unauthorized connection of a transmitting cable to the connector may be prevented by covering the connector with the covering member.

The structures and characteristics of this invention can be realized by referring to the appended drawings and explanations of the preferred embodiments.

### BRIEF DESCRIPTION OF THE SEVERAL VIEWS OF THE DRAWINGS

FIG. 1 is a schematic view showing the rear of a laptop computer;

FIG. 2 is a schematic perspective view showing a preferred embodiment according to this invention;

FIG. 3 is a schematic exploded view showing the preferred embodiment of FIG. 2;

FIG. 4 is a cross-sectional view showing the embodiment of FIG. 2 in which the housing is disengaged from the covering member;

FIG. 5 is a cross-sectional view showing the embodiment of FIG. 2 in which the housing engages the covering member;

FIG. 6 is a partial cross-sectional view showing another preferred embodiment of this invention wherein the lock mechanism thereof is in an unlocked state;

FIG. 7 is a partial cross-sectional view showing the embodiment of FIG. 6 in which the lock mechanism is in a locked state;

FIG. 8 is a schematic view showing one state of use of the embodiment of FIG. 2;

FIG. 9 is a schematic perspective view showing yet another preferred embodiment of this invention;

FIG. 10 is a partial cross-sectional view showing the other preferred embodiment of this invention in which the housing is disengaged from the covering member;

FIG. 11 is another partial cross-sectional view showing the embodiment of FIG. 10 in which the housing engages the covering member;

FIG. 12 is a perspective view showing the other preferred embodiment of this invention in which the fastening device is disengaged from the screw hole;

FIG. 13(a) is a partial cross-sectional view showing the preferred embodiment in FIG. 12, prior to the fastening device engaging the screw hole;

FIG. 13(b) is another partial cross-sectional view showing the preferred embodiment in FIG. 12, at the state where the fastening device engages the screw hole;

FIG. 14 is a partial cross-sectional view showing the other preferred embodiment of this invention, at the state where the fastening device engages the screw hole;

FIG. 15 illustrates the detailed construction of the fastening device in FIG. 14;

FIG. 16 illustrates a perspective view another preferred embodiment of this invention;

FIG. 17 is a perspective view showing the internal structure of the lock mechanism in FIG. 16;

FIG. 18 is a cross-sectional view showing the embodiment of FIG. 16 wherein the lock mechanism thereof is in an unlocked state;

FIG. 19 is a cross-sectional view showing the embodiment of FIG. 16 in which the lock mechanism is in a locked state;

FIG. 20 illustrates a perspective view another preferred embodiment of this invention;

FIG. 21 is an exploded view showing the lock mechanism of the embodiment of FIG. 20;

FIG. 22 is a cross-sectional view showing the embodiment of FIG. 20 wherein the lock mechanism thereof is in an unlocked state;

FIG. 23 is a cross-sectional view showing the embodiment of FIG. 20 in which the lock mechanism is in a locked state;

FIG. 24 illustrates a cross-sectional view of another preferred embodiment of this invention, in which the lock mechanism thereof is in a locked state; and

FIG. 25 is a cross-sectional view taken along lines 25-25 of FIG. 24.

### DETAILED DESCRIPTION OF THE INVENTION

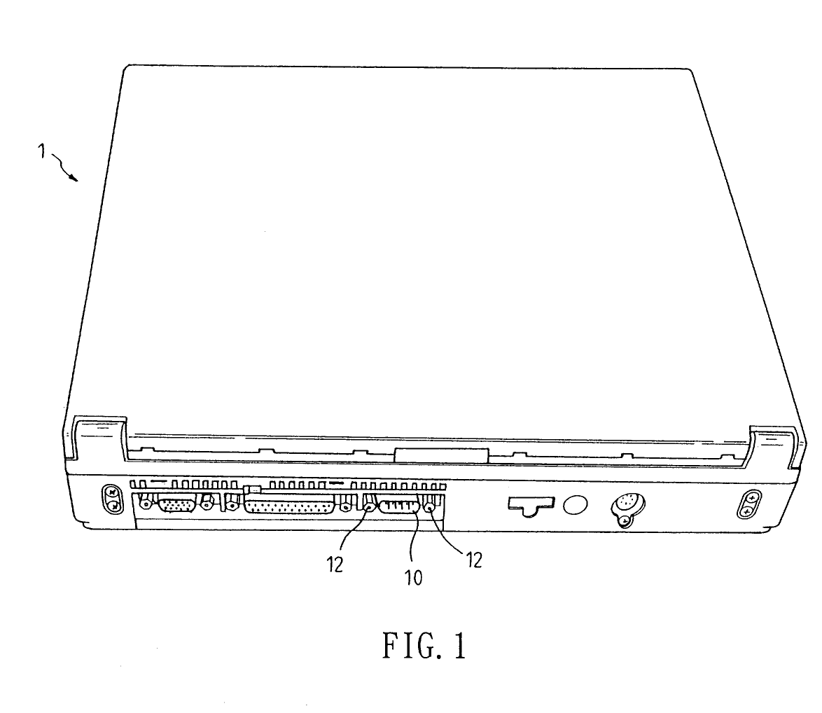

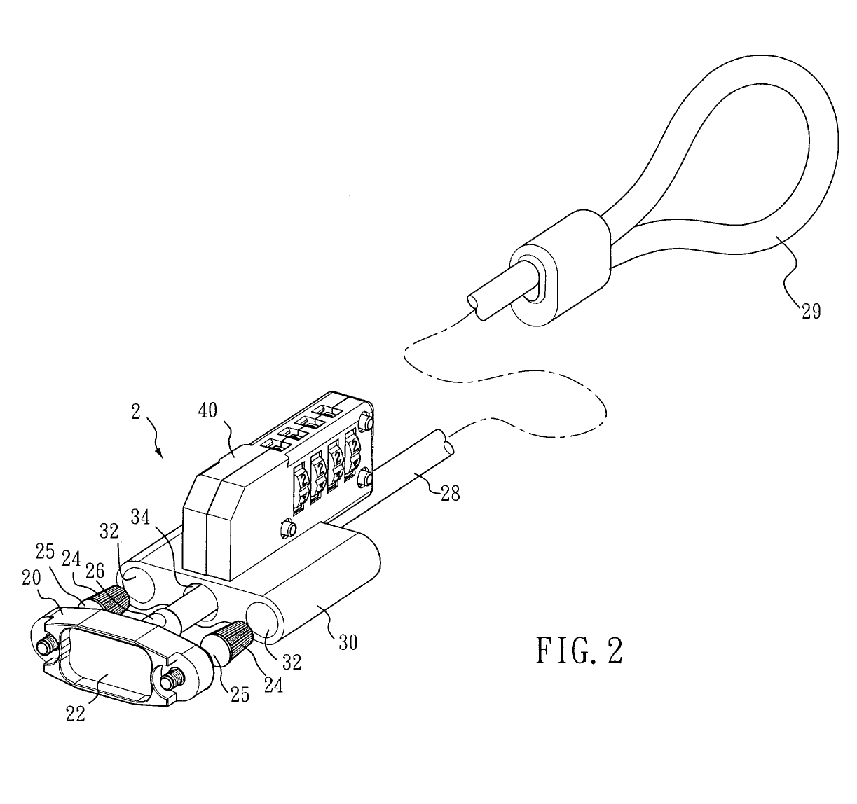

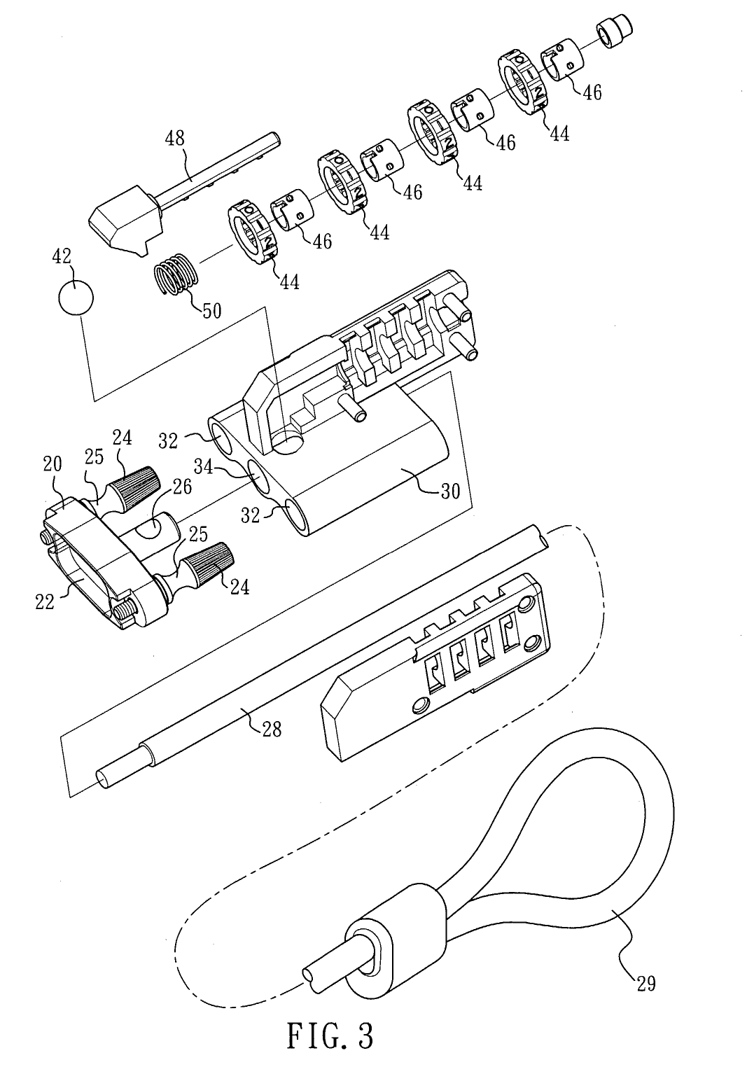

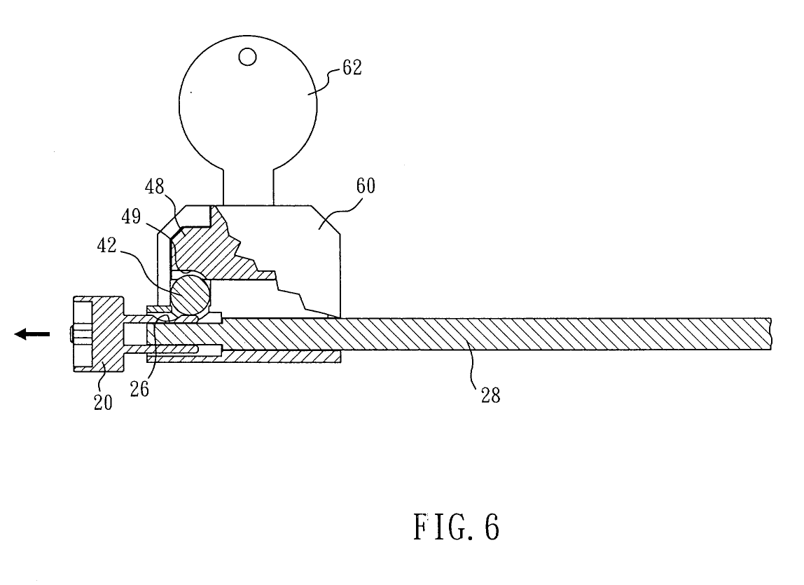

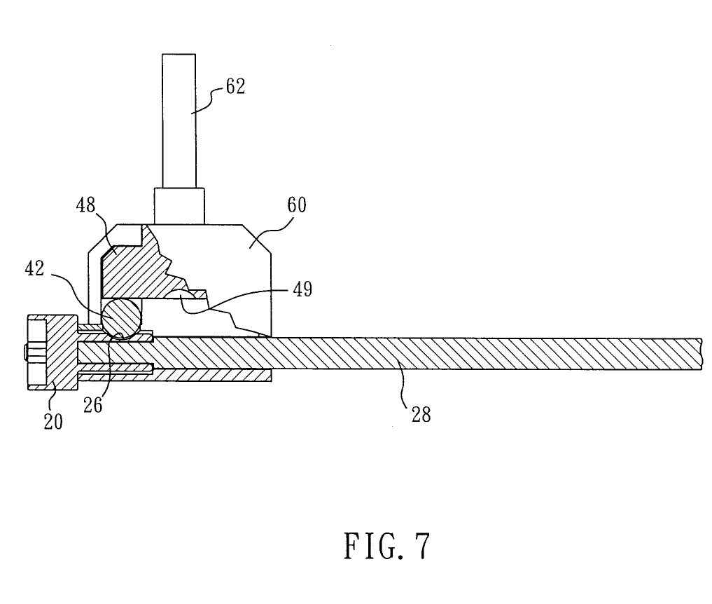

This invention is related to a securing device 2, as shown in FIG. 2, for securing a connector 10 of a computer 1, such as the laptop computer shown in FIG. 1. FIG. 2 is a schematic perspective view illustrating one of the preferred embodiments of this invention and FIG. 3 is the exploded view thereof. The securing device 2 comprises a covering member 20 for covering the connector 10. The covering member 20 defines a receiving space 22 in a generally rectangular shape with rounded corners. The receiving space 22 has a substantially identical width at the upper and lower sides thereof and the width is slightly larger than the maximum width of the connector 10. Thus, the securing device 2 of this invention can engage the connector 10 from either side without being limited to the trapezoid shaped connector 10 with different widths. The covering member 20 has at least one fastening device, such as the two bolts 24 of the current preferred embodiment, for fastening to the two screw holes 12 next to the connector 10. The securing device 2 is further provided with a lock mechanism. The lock mechanism includes a housing 30 having two indents 32 for receiving and covering the two bolts 24. The lock mechanism can be selected from, but is not limited to, any type of lock, such as the combination lock 40 shown in FIGS. 2 to 5, the key lock 60 shown in FIGS. 6 and 7, etc., as long as the lock can be used to lock the housing 30 to the covering member 20.

The covering member 20 has a recess 26, and the lock mechanism has a latch 42 to be inserted thereinto. In the current preferred embodiment, the latch 42 is a ball and the recess 26 is a semi-spherical corresponding recess. Of course, the latch 42 and the recess 26 can be other appropriate shapes and should not be constrained to those illustrated in the preferred embodiments. For example, the latch 42 and the recess 26 may be provided to the lock mechanism and the covering member 20, respectively, so long as they shapes are complimentary to one another to allow locking effects.

The covering member 20 has a cable 28 at the side opposite to the receiving space 22. The housing 30 further has an aperture 34 so that the cable 28 is passed therethrough and the housing 30 can be moved back and forth along the cable 28. However, it is emphasized that the cable 28 is an auxiliary device in order to achieve additional purposes related in this invention rather than an essential device. That is, even without the provision of the cable 28, the securing device 2 of this preferred embodiment can still achieve the object of securing the connector 10.

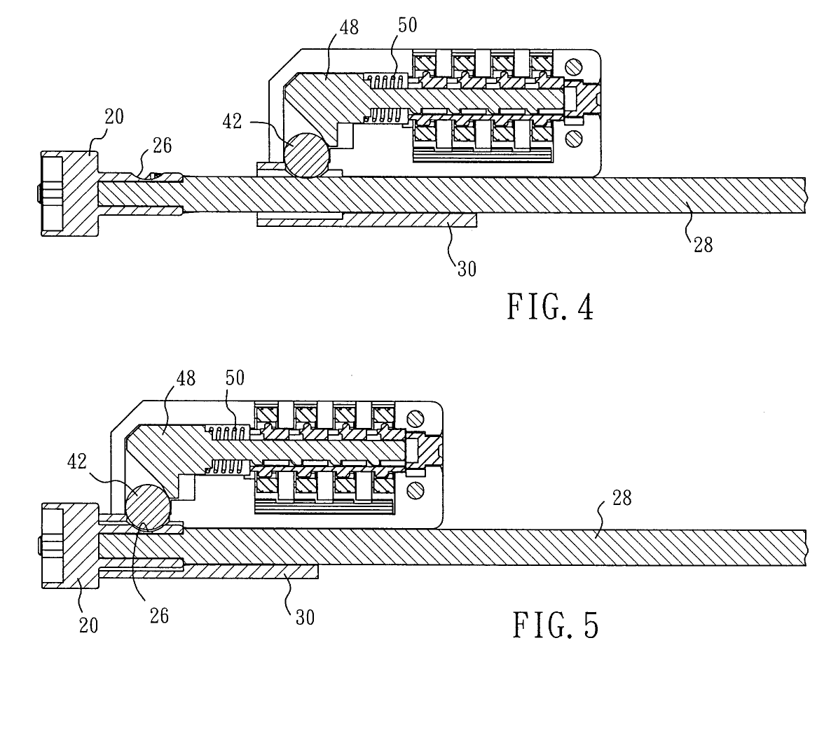

The detailed structures and locking measures of the combination lock 40 utilized in the preferred embodiment of this invention can be referred to the exploded view of FIG. 3 and the cross-sectional views of FIGS. 4 and 5. It is emphasized again that the lock mechanism can be variously designed to achieve the objects of this invention and should not be limited to those disclosed in the preferred embodiments.

In the current embodiment, the combination lock 40 has a plurality of dials 44 and sleeves 46, in which a control member 48 is extended therethrough. A spring 50 is provided between the control member 48 and the dials 44. When the lock mechanism is in an unlocked state, which is known to the persons skilled in the art, the control member 48 is not restrained by the sleeves 46 and can be moved back and forth. Thus, when the housing 30 is moved along the cable 28 between a position disengaged from the covering member 20 as shown in FIG. 4 and a position engaging the covering member 20 as shown in FIG. 5, the latch 42 is basically free to move up and down. Nonetheless, the latch 42 is resiliently pressed by the control member 48, which is biased by the spring 50. Therefore, the latch 42 keeps in contact with the cable 28 or the recess 26 all the time. When the housing 30 is moved along the cable 28 to be engaged to the covering member 20 such as that shown in FIG. 5, the latch 42 is pressed into the recess 26 by the control member 48 that is biased by the spring 50. In this position, the head portions of the two bolts 24 of the covering member 20 are received within the two indents 32 and enveloped by the housing 30. The user may, at this stage, rotate the dials 44 of the combination lock 40, which thereby assumes a locked state. Thus, the control member 48 is restrained by the sleeves 46 and cannot be moved. Accordingly, the latch 42 is locked within the recess 26 and cannot be removed therefrom by upwardly pushing the control member 48. As a result, the housing 30 and the covering member 20 are locked together. After the housing 30 is locked to the covering member 20, since the head portions of the two bolts 24 of the covering member 20 are enveloped by the housing 30, the two bolts 24 cannot be reached unless the combination lock 40 is unlocked. Therefore, the connector 10 is covered by and locked to the covering member 20 and the connector 10 of the computer is thereby covered.

FIGS. 6 and 7 are the cross-sectional schematic views showing that a key lock 60 is utilized as the lock mechanism of this invention. FIG. 6 shows the key lock 60 is in an unlocked state, that is, the control member 48 does not resist against the latch 42 due to the provision of a cavity 49 thereon. Thus, the latch 42 can be moved up and down freely or out of the recess 26. When the control member 48 is rotated by rotating the key 62, the cavity 49 is thereby displaced and the key lock 60 is changed to a locked state such as that shown in FIG. 7 and thus, the control member 48 resists against the latch 42. Accordingly, the latch 42 is locked within the recess 26 and cannot be removed therefrom.

In the preferred embodiments shown in FIGS. 2 and 6, the cable 28 may further form with a loop 29 at one end such that the securing device 2 of this invention can be passed therethrough. Thus, if the cable 28 is further wrapped with a fixture, such as a leg 70 of a table illustrated in FIG. 8, the computer 1 can be locked to the leg 70 and cannot be removed.

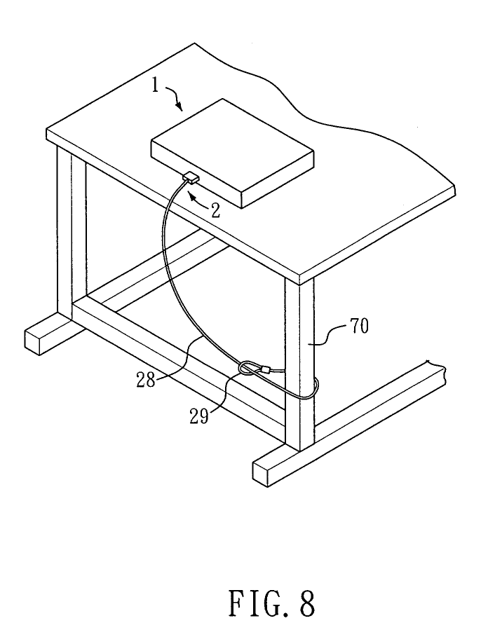

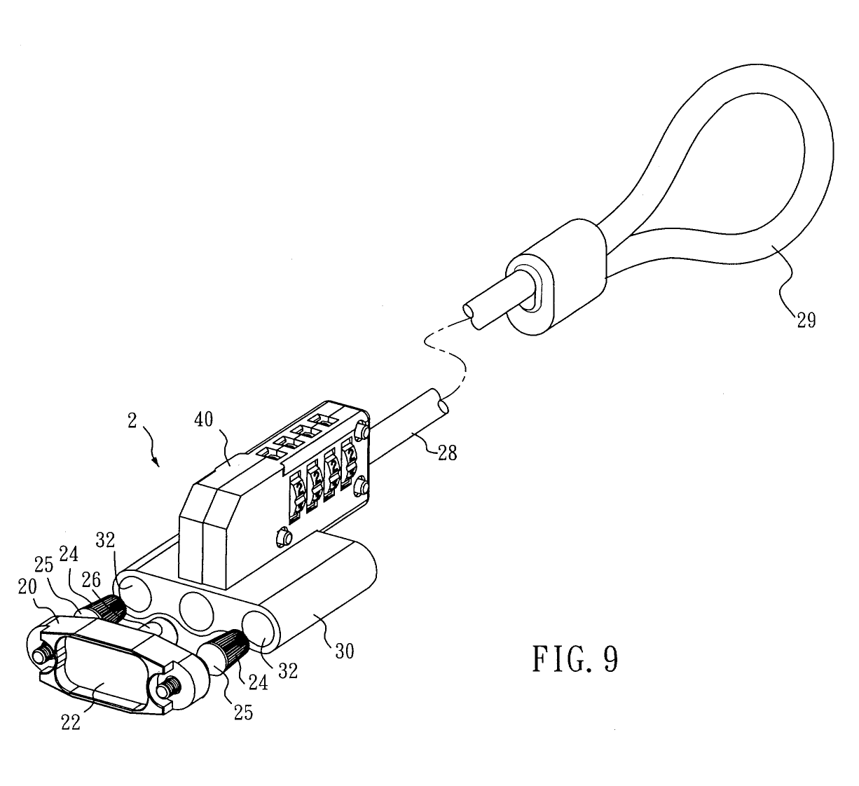

In yet another preferred embodiment of this invention such as that shown in FIG. 9, the cable 28 can be provided on the combination lock 40 and the same object can still be achieved.

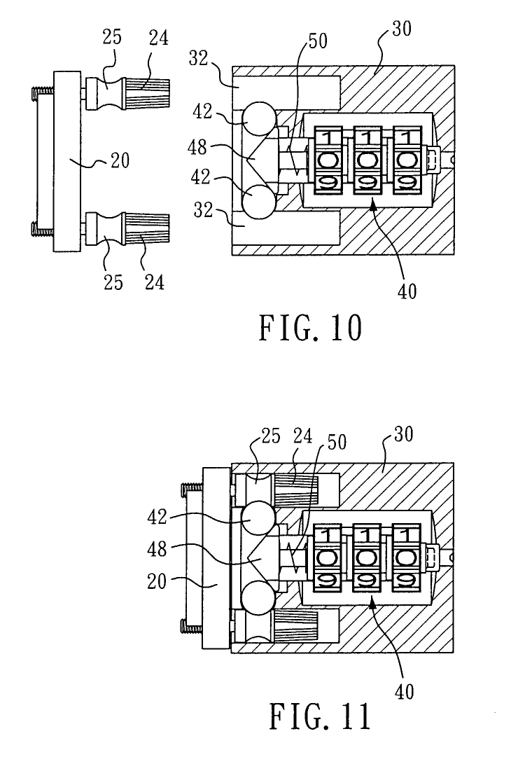

FIGS. 10 and 11 shows the other preferred embodiment according to this invention in which the design of the covering member 20 and the two bolts 24 are substantially the same as that disclosed in previous embodiments. Each of the bolts 24 has a threaded portion at one end, and a head portion at the other end. The head portion further forms a neck 25. The housing 30 also has two indents 32 for receiving and enveloping the head portions, including the necks 25, of the two bolts 24. The lock mechanism has a control member 48 and two spherical latches 42 resisting thereon at both sides. When the lock mechanism is in an unlocked state, the control member 48 is basically free to be moved back and forth. Thus, the latches 42 may be transversely moved but still under slight resilient compression biased from the spring 50 on the control member 48. After the housing 30 engages the covering member 20, the latches 42 fall into the necks 25 of the bolts 24 due to the compression of the control member 48 due to the resilient force of the spring 50, as illustrated in FIG. 11. At this time, the head portions of the two bolts 24 of the covering member 20 are received in the two indents 32 and enveloped by the housing 30. If the user sets the lock mechanism into a locked state, the latches 42 is locked within the necks 25 of the bolts 24 and cannot be removed therefrom. As a result, the housing 30 and the covering member 20 are locked together. Since the head portions of the two bolts 24 of the covering member 20 are enveloped by the housing 30, the two bolts 24 cannot be reached unless the lock mechanism is unlocked, and the housing 30 and the covering member 20 cannot be disengaged. Therefore, the connector 10 is covered by and locked to the covering member 20.

In the present preferred embodiment, a cable (not shown) can also be provided on the housing 30 or the lock mechanism, similar to that disclosed in previous embodiments, so as to lock the computer to an appropriate fixture.

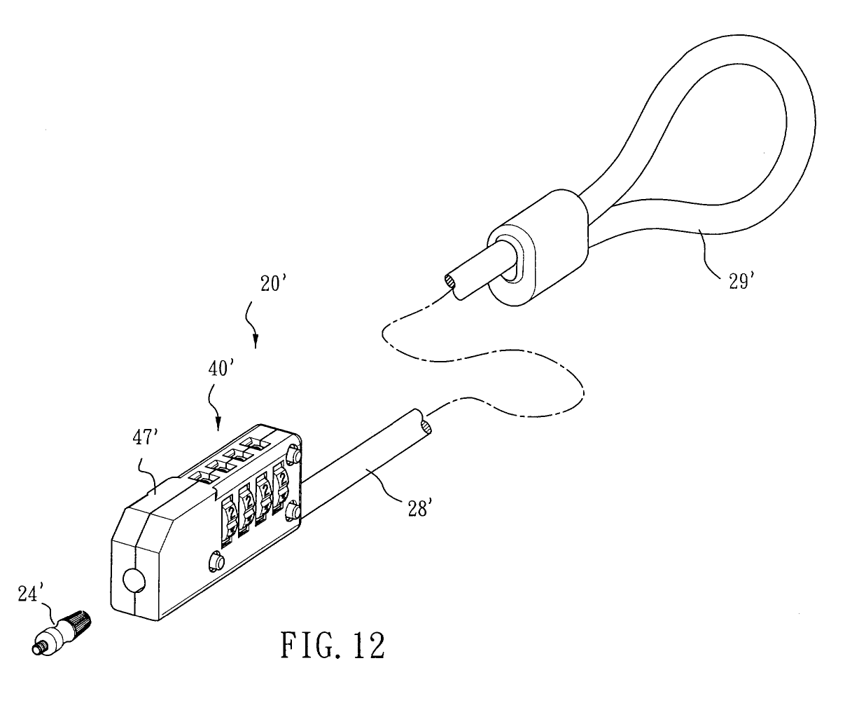

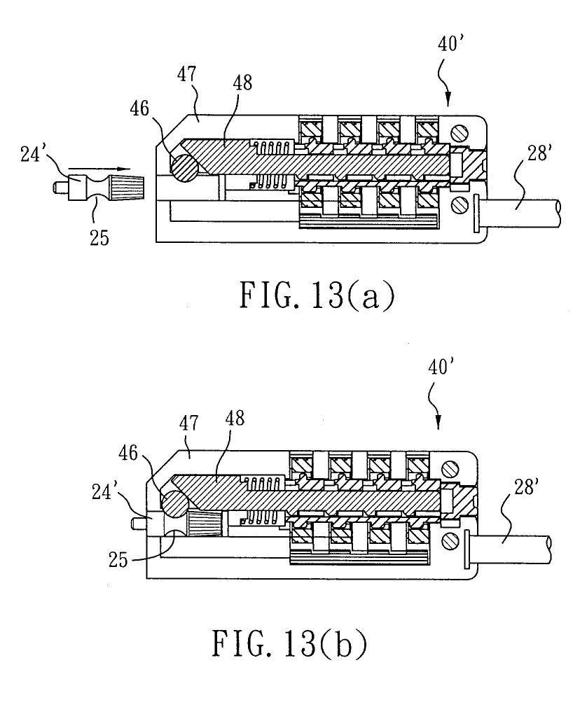

FIG. 12 is another embodiment of this invention having features substantially similar to those discussed above, other than that the securing device in FIGS. 12, 13(a) and 13(b) may be adapted to secure any equipment equipped with a screw hole. Based on such an embodiment, the securing device 20′ includes: at least one fastening device, such as a bolt 24′ shown in this embodiment, for engaging the screw hole; and a lock mechanism, such as the combination lock 40′ as illustrated. The lock mechanism includes a housing 47 adapted for enveloping the bolt 24′ and the lock mechanism may be switched between a locked state and an unlocked state.

As such, after the bolt 24′ engages the screw hole, the housing 47 of the lock mechanism may envelope the bolt 24′ and the housing 47 of the lock mechanism is locked to the bolt 24′ by the inter-corporation of the latch 42 falling into a neck 25 of the bolt 24 due to the compression of the control member 48 and the combination lock 40′ such that the bolt 24′ cannot be detached from the screw hole, as shown in FIG. 13(b), thereby securing the equipment equipped with the screw hole.

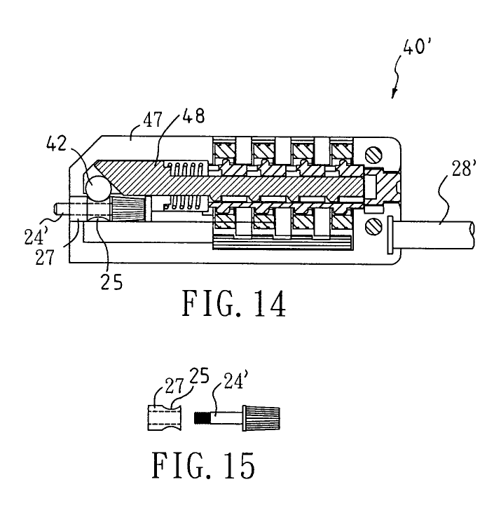

FIG. 14 is another embodiment of this invention having features substantially similar to those in FIG. 12. In this embodiment, the fastening device includes: a bolt 24′ and a sleeve 27 which is rotatably mounted to the bolt 24′ by a retainer (not shown) or riveting, such as those shown in FIG. 15.

The fastening device in this embodiment can further prevent others from driving rotation of the bolt 24′ due to the high friction force created between the latch 42 and the bolt 24, such that the lock mechanism will not be detached from the screw hole when the lock mechanism is still under the locked state. The sleeve 27 may include a variety of dimensions for adapting bolts 24′ of various specifications.

The securing devices in FIGS. 12 and 14 are each further provided with a cable 28′ having an end fixed to the securing device and another end to be connected to a fixture, such as that shown in FIG. 8, thereby securing the equipment equipped with the screw hole, preventing theft of the equipment.

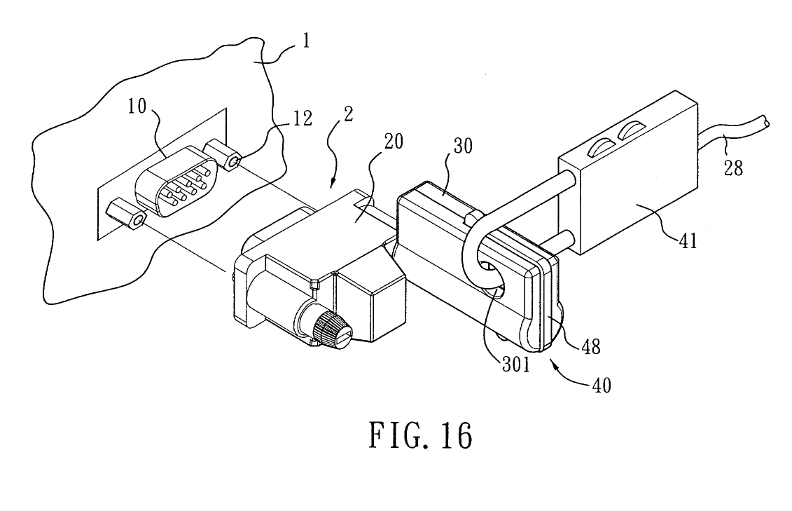

FIG. 16 is another embodiment of this invention having features substantially similar to those discussed in FIGS. 10-11, except for that a drawing type lock 40″ to be locked by a padlock 41 is illustrated. The padlock 41 is passed through an opening 481 formed on the control member 48 and a corresponding opening 301 formed on the lock housing 30 when the drawing type lock 40″ is in a locked stated illustrated in FIGS. 16 and 19.

As such, after the bolt 24 engages the screw hole 12, the housing 30 of the drawing type lock 40″ may envelope the bolt 24 and the housing 30 of is locked to the bolt 24 by means of a latch 42 falling into a neck 25 of the bolt 24 due to the compression of the control member 48. The bolt 24 cannot be detached from the screw hole 12, as shown in FIG. 19, when a padlock 41 is locked to the housing 30 and the control member 48, whereby the covering member 20 covers the connector 10 such that the connector 10 cannot be used.

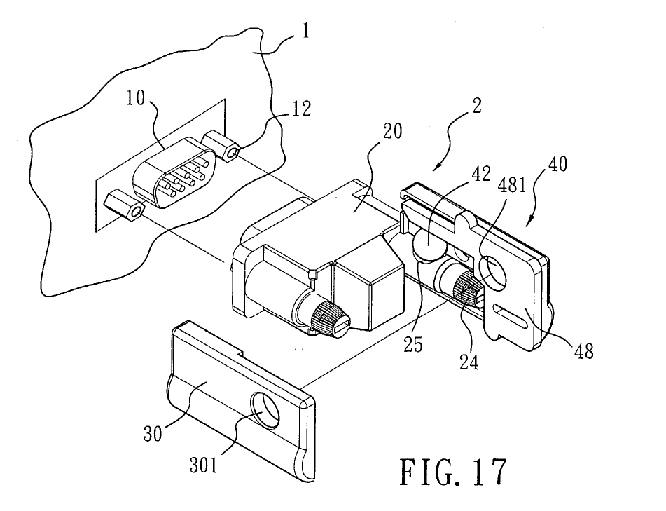

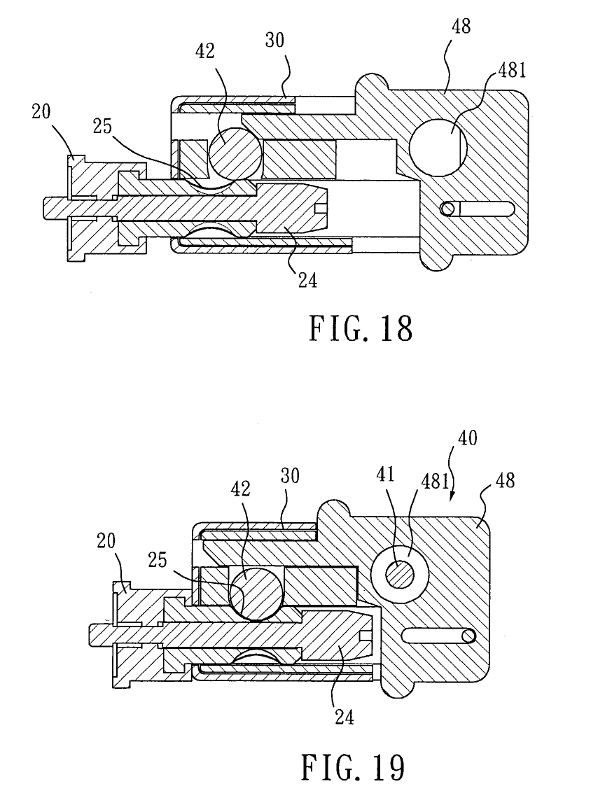

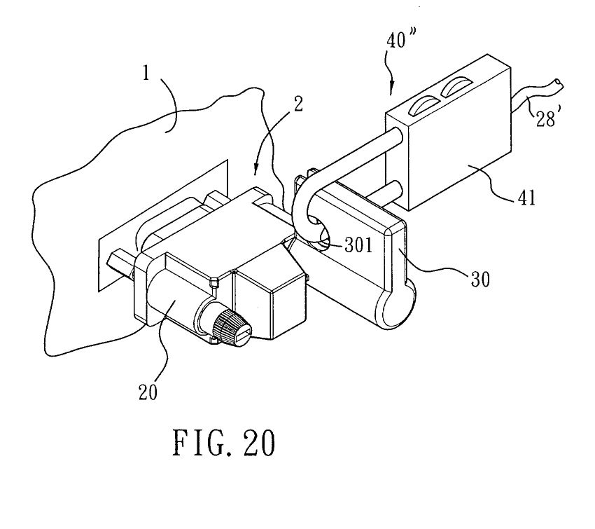

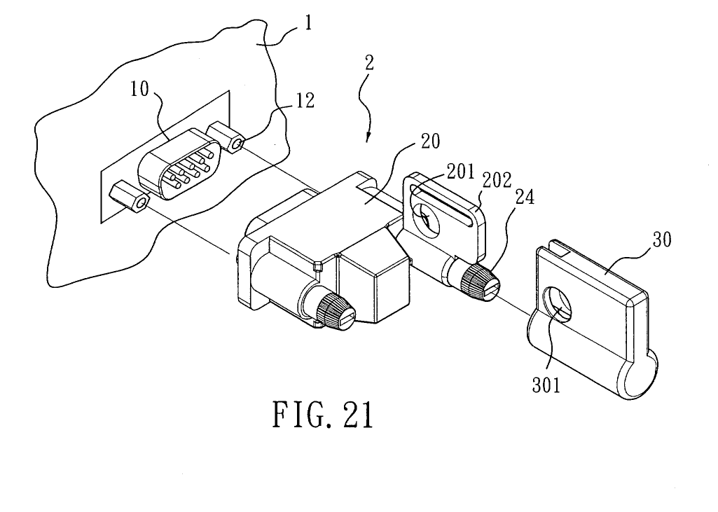

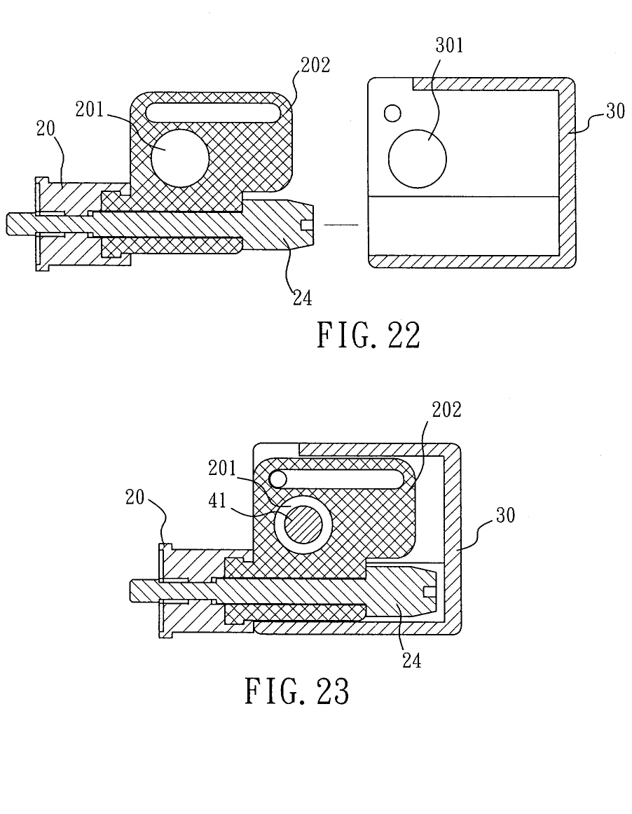

FIGS. 20 and 21 is another embodiment of this invention having features substantially similar to that in FIGS. 16-20, except for that in this particular drawings type lock 40″, the housing 30 formed with the opening 301 now co-operates with a flange 202 extending from the covering member 20 and a padlock 41, wherein a opening 201 corresponding to the opening 301 is formed on the flange 202, to allow switching between an unlocked state and a locked state.

As such, after the bolt 24 engages the screw hole 12, the housing 30 of the drawing type lock 40″ envelopes the bolt 24 and the flange 202. The bolt 24 cannot be detached from the screw hole 12, as shown in FIG. 23, when a padlock 41 is locked to the housing 30 and the flange 20, whereby the covering member 20 covers the connector 10 such that the connector 10 cannot be used.

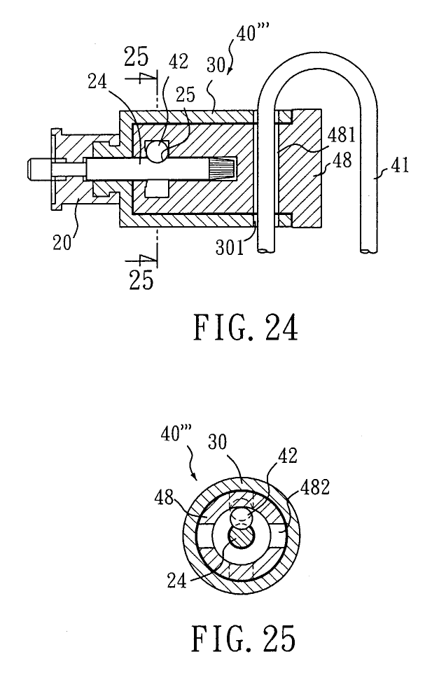

FIG. 24 is another embodiment of this invention having features substantially similar to those discussed in FIGS. 10-11 and FIGS. 16-20, except for that a rotary lock 40′″ to be locked by a padlock 41 is illustrated. The padlock 41 is passed through an opening 481 formed on the control member 48 and a corresponding opening 301 formed on the lock housing 30 when the rotary lock 40′″ is in a locked stated illustrated in FIGS. 24 and 25.

Similar to those discussed in FIGS. 10-11 and FIGS. 16-20, after the bolt 24 engages the screw hole, the housing 30 of the rotary 40′″ may envelope the bolt 24 and the housing 30 is locked to the bolt 24 by means of a latch 42 falling into a neck 25 of the bolt 24 due to the compression of the control member 48 as shown in FIGS. 24 and 25. As such, the bolt 24 cannot be detached from the screw hole 12 when a padlock 41 is locked to the housing 30 and the control member 48, whereby the covering member 20 covers the connector 10 such that the connector 10 cannot be used.

To unlock the rotary lock 40′″, after removing the padlock 41, the control member 48 is rotated for 90 degrees such that the latch 42 is basically free to move up and down in an indent 482 formed on the control member 48, as shown by the phantom lines in FIG. 25.

In the embodiments of FIGS. 16, 20, and 24, elimination of the covering member 20 allows the securing device to be adapted for securing the equipment equipped with the screw hole, preventing theft of the equipment, similar to that shown in FIG. 12.

This invention is related to a novel creation that makes a breakthrough in the art. Aforementioned explanations, however, are directed to the description of preferred embodiments according to this invention. Various changes and implementations can be made by persons skilled in the art without departing from the technical concept of this invention. Since this invention is not limited to the specific details described in connection with the preferred embodiments, changes to certain features of the preferred embodiments without altering the overall basic function of the invention are contemplated within the scope of the appended claims.

### Sequence Listing

1 laptop computer

2 securing device

10 connector

12 screw holes

20 covering member

22 receiving space

24, 24′ bolts

25 neck

26 recess

27 sleeve

28, 28′ cable

29 closed loop

30 housing

34 aperture

40, 40′ combination lock

40″ drawing type lock

40′″ rotary lock

42 latch

44 dials

46 sleeves

48 control member

49 cavity

50 spring

60 key lock

62 key

70 leg of table

201 opening

202 flange

301 opening

481 opening

482 indent

1. A securing device, comprising:
at least one fastening device for engaging a screw hole;
a lock mechanism, having a housing formed with an indent for enveloping the fastening device, to be switched between an unlocked state and a locked state, wherein when the lock mechanism is at the locked state, the fastening device is prevented from being detached from the screw hole; and
a cable, having an end fixed to the lock mechanism and another end to be connected to a fixture.

2. The securing device according to claim 1, wherein one of the fastening device and the lock mechanism has a neck, and the other of the fastening device and the lock mechanism has a latch to be inserted into the neck.

3. The securing device according to claim 2, wherein the at least one fastening member is a bolt having the neck.

4. The securing device according to claim 2, wherein the at least one fastening device includes a bolt and a sleeve rotatably mounted to the bolt, wherein the sleeve is formed with the neck.

5. The securing device according to claim 1, wherein the lock mechanism is adapted to lock the at least one fastening device.

6. A securing device, comprising:
a covering member; and
at least one fastening device provided to the covering member, for engaging a screw hole;
a lock mechanism, having a housing formed with an indent for enveloping the fastening device, to be switched between an unlocked state and a locked state, wherein when the lock mechanism is at the locked state, the fastening device is prevented from being detached from the screw hole.

7. The securing device according to claim 6, wherein the lock mechanism further includes a control member provided in the housing, the housing and the control member being each formed with an opening through with a cable may pass rendering the lock mechanism in the locked state.

8. The securing device according to claim 6, wherein the covering member is adapted to cover a connector on a computer.

9. The securing device according to claim 6, wherein one of the fastening device and the lock mechanism has a neck, and the other of the fastening device and the lock mechanism has a latch to be inserted into the neck

10. The securing device according to claim 6, wherein the at least one fastening member is a bolt having the neck, and the housing includes the indent for enveloping the bolt.

11. A securing device, comprising:
a covering member;
at least one fastening device provided to the covering member, for engaging a screw hole;
a lock mechanism, having a housing formed with an indent for enveloping the fastening device and an aperture, to be switched between an unlocked state and a locked state, wherein when the lock mechanism is at the locked state, the fastening device is prevented from being detached from the screw hole; and
a cable having an end connected to the covering member and passing through the aperture.

12. The securing device according to claim 11, wherein the covering member is adapted to cover a connector on a computer.

13. The securing device according to claim 12, wherein one of the covering member and the lock mechanism has a recess, and the other of the covering member and the lock mechanism has a latch to be inserted into the recess.

14. The securing device according to claim 11, wherein the at least one fastening device includes two bolts, and the housing has two indents for receiving the two bolts.

15. The securing device according to claim 14, wherein the bolts are each formed with a neck, the lock mechanism includes a lock latch for locking to the neck.

16. A securing device, comprising:
a covering member; and
at least one fastening device provided to the covering member, for engaging a screw hole;
a lock mechanism, having a housing formed with an indent for enveloping the fastening device, to be switched between an unlocked state and a locked state, wherein when the lock mechanism is at the locked state, the fastening device is prevented from being detached from the screw hole; and
a cable having an end fixed to the lock mechanism.

17. The securing device according to claim 16, wherein the covering member is adapted to cover a connector on a computer.

18. The securing device according to claim 16, wherein one of the covering member and the lock mechanism has a recess, and the other of the covering member and the lock mechanism has a latch to be inserted into the recess.

19. The securing device according to claim 16, wherein the at least one fastening device includes two bolts, and the housing has two indents for receiving the two bolts.

20. The securing device according to claim 19, wherein the bolts are each formed with a neck, the lock mechanism includes a lock latch for locking to the neck.
